(19) United States
(12) Patent Application Publication
(10) Pub. No.: US 2026/0348469 A1
(43) Pub. Date: Nov. 5, 2026

(54) MEANS OF TRANSPORT AND METHOD FOR OPERATING A MEANS OF TRANSPORT WITH HIGH EFFICIENCY

(71) Applicant: Porsche eBike Performance GmbH, Ottobrunn (DE)

(72) Inventor: Mark FOLIGNO, Berlin (DE)

(73) Assignee: Porsche eBike Performance GmbH, Ottobrunn (DE)

(21) Appl. No.: 19/112,522

(22) PCT Filed: Oct. 10, 2023
(86) PCT No.: PCT/EP2023/078053

§ 371 Date: Mar. 17, 2025

(30) Foreign Application Priority Data
Oct. 12, 2022 (DE) 10 2022 126 513.7

(51) Int. Cl. F16H 61/02; F16H 59/00; F16H 59/44; F16H 59/60; F16H 59/62; F16H 59/64; F16H 59/66

(52) U.S. Cl. CPC F16H 61/0213; F16H 2059/003; F16H 59/44; F16H 2059/605; F16H 59/62; F16H 59/64; F16H 2059/666; F16H 2061/0227

(57) ABSTRACT

A transport apparatus has a variator (12), a measurement system (18) for measuring a position of the transport apparatus, a position history of the transport apparatus, a speed of the transport apparatus and a switching state of the variator (12). A database (22) stores comparative data (24) that includes switching states (26) for different position histories. An output unit (28) proposes a switching state stored in the database (22) for the current position and/or automatically sets the switching state stored for the current position in the variator (12). The comparative data (24) for at least one position histories have more than one set of stored switching states (26), and a selection unit (20) selects one of the sets for the output unit (28). The switching states (26) that are able to be selected by the switching unit (20) adapt the transport apparatus to a current situation.

### FIELD OF THE INVENTION

The invention relates to means of transport and a method for operating a means of transport with the aid of which a person is to be moved as efficiently as possible.

### BACKGROUND OF THE INVENTION

EP 3 133 541 A1 discloses a bicycle in which a driven route, road conditions, travel speed and the actuation of a gear shift are measured and compared with stored data in order to suggest to the driver a gear shift strategy stored for comparable boundary conditions. The stored data can be based on previous measurement data.

There is a constant need to adapt the operation of a means of transport as efficiently as possible to the current situation.

The object of the invention is to demonstrate measures that enable a means of transport that is efficiently adapted to the current situation.

### SUMMARY OF THE INVENTION

One aspect relates to a means of transport for moving a person on the ground, on water and/or in the air. The means of transport in accordance with this aspect of the invention has a variator, in particular a gear shift, for changing a transmission ratio between a drive torque and an output torque and/or output thrust The means of transport in accordance with this aspect of the invention also may comprise a measuring system for measuring a position of the means of transport, a position profile of the means of transport, a transport speed of the means of transport and a switching state of the variator. The means of transport also may comprise a database containing comparison data. The comparison data for various position histories have stored switching states for the respective position of the position history, and an output unit for proposing a switching state stored in the database for the current position and/or for automatically setting the switching state stored for the current position in the variator. The comparison data for at least one specific position history has more than one record of stored switching states for the respective position of the position history and a selection unit for selecting one of the records is provided for the output unit.

It has been recognized that adapting a means of transport to the current situation as efficiently as possible should not fall back on a data record stored for the current route, which results from the measured position profile. Rather, the optimum adaptation depends not only on the route, but also on changing boundary conditions. For example, in the case of a means of transport designed as a ground vehicle, an optimized drive power and an associated optimal switching state of the variator depend on the road conditions, not least for safety reasons. Thus, a higher transport speed is possible on a dry road than on a wet road. This applies if the means of transport is a sports car or racing car and is to be driven as optimally as possible over a known race track in a race. Adapting a data record with stored switching states for the current position progression to the actual current driving behavior of the driver would take far too long and would not be sufficiently suitable for a subsequent further change in the boundary conditions. However, more than one record of switching states for the same position profile is stored in the comparison data of the database. Thus, it is possible, depending on a specific selection criterion, to use the selection unit to select a record that best matches this selection criterion and to disregard the other record of switching states stored for this position profile. However, the unconsidered data record of switching states is not deleted, overstored or varied with the aid of current measurement data, but is retained unchanged. As a result, the current unconsidered record of switching states is available in its optimized form if this record is selected by the selection unit using the selection criterion in a different driving situation with different boundary conditions. Due to the multiple records of switching states that can be selected by the selection unit, a record that is better optimized for changing boundary conditions can be used for a current position profile of the means of transport, so that the variator enables a means of transport that is efficiently adapted to the current situation even under different boundary conditions.

The means of transport can be a ground vehicle, watercraft, aircraft or spacecraft. In particular, the means of transport can have an autonomous drive unit, for example an electric machine and/or an internal combustion engine that can be supplied with drive energy from a storage source, for example a battery and/or a fuel tank. Additionally, or alternatively, the means of transport can be designed for muscle-powered propulsion by the rider. This is the case, for example, with a bicycle or a scooter.

The variator can be designed for stepless or incremental conversion of a speed and/or torque between a drive side and an output side of a drivetrain. For example, the variator may be a gear shift, a shiftable stepped transmission or a continuously variable transmission, such as a planetary transmission or bevel gear wrap transmission. The variator can be set to a specific transmission ratio by external intervention by the driver and/or the output unit. The transmission ratio set in the variator can be used to operate the drive unit at the best possible operating point, in which, for example, fuel consumption is minimized or drive power can be maximized, and/or to enable the most effortless muscle-powered drive possible.

The measuring system can have plural measuring sensors that can be used to measure various parameters for the current operating situation and selection criteria for the selection unit. For example, the measuring system can have a position determination sensor, in particular a GPS sensor, that can be used to measure the current position and a position profile that corresponds to a current route. With the help of map material stored in the database, the further course of the position can be predicted within certain limits and further data linked to this course of the position, for example traffic regulations, can be determined, from which conclusions can be drawn from changing boundary conditions. For example, the measuring system can have a speed sensor for detecting the transport speed of the means of transport. The transport speed is usually a value specified by the driver, which depends, for example, on current traffic volumes and can be used to determine a specific boundary condition for selecting one of the stored data records. The measuring system can also have a timer, for example a clock, to measure a time in absolute or relative terms. For example, the average transport speed in a certain position can be deduced from the duration of time for this position. In addition, the measuring system can measure the switching state, in particular the currently set transmission ratio, in order to determine a need for action to change this switching state with the help of the comparative data stored in the database.

The database can maintain indexed comparison data for several position courses, which may correspond to a certain route. The comparison data, in turn, may contain several data records of switching states for different operating situations, and these several data records can be stored for different boundary conditions that can occur for the position course under consideration. In particular, the database can have the comparison data relevant for the respective position course and/or neighboring position courses stored locally in the means of transport. Thus, it is possible that the comparison data relevant for a region was previously transferred from an external data server. If none of the stored data records match the current driving situation well enough, the output unit can be deactivated until a data record suitable for the current driving situation can be selected from the comparison data. Incorrect information and/or unfavorable settings for the variator can thus be avoided and the most favorable operation can remain the responsibility of the driver. In particular, this time period can be used to detect a further data record for the current position progression and learn it, preferably with the help of an AI. The data record determined in this way can be reused in a comparable situation and further improved by learning with the help of the AI.

Depending on a selection criterion, the selection unit can be set up to select a data record that is best suited for this selection criterion and, in particular, a measured or stored amount for this selection criterion. For example, various data records of switching states indexed for this selection criterion are stored in the comparison data for the position profile under consideration. If the selection unit is to select a data record, the selection unit can, for example, first select the comparison data relevant for the current position or the current position history, check whether the comparison data shows more than one data record of switching states and, in this case, use the at least one selection criterion to select the data record of switching states that best matches the at least one selection criterion.

Depending on the selection made by the selection unit, the output unit can trigger a reaction adapted to the selected data record of switching states. The reaction can be purely informative, in that the driver is signaled the switching state stored as optimal. However, the reaction of the output unit can also be designed as a control intervention in that the output unit in the variator automatically sets the switching state stored as optimal. Preferably, the driver can set whether the output unit is allowed to change the switching state on the variator directly or only informs the driver to change the switching state

The selection unit of some embodiments is designed to select one of several stored records depending on the current travel speed. This allows, for example, a traffic jam to be taken into account, which requires a significantly lower transport speed than usual. In particular, this allows an optimized switching state to be implemented as a function of the current transport speed, and takes into account that a different operating point of the drive unit is specified in the event of a traffic jam or other current boundary conditions that differ from the usual expected operating situation. In particular, the transport speed can be a good indicator that a currently selected data record of switching states, for which other transport speeds are actually assumed, is not suitable after all and another data record should be selected or even no data record at all should be selected if none of the stored data records is suitable enough. In this case, the output unit can be deactivated until a data record suitable for the current driving situation can be selected again from the comparison data.

In some embodiments, the selection unit is designed to select one of several stored records depending on the current weather conditions. This makes it possible to take into account the fact that, depending on the weather conditions, an aircraft can fly at different altitudes and requires a different strategy for the variator due to the different altitude. In the case of a ground vehicle, this makes it possible to react to different road conditions due to dryness or wetness and to adapt the switching state of the variator to a particularly safe driving style.

The selection unit of some embodiments is designed to select one of several stored records depending on the traffic regulations currently in force. Traffic regulations, in particular speed limits, can change over time so that a previously permitted driving style is no longer permitted. In particular, it is also possible that different traffic regulations and/or different driving routes are permitted in certain time zones, for example for noise protection reasons. By taking into account changing boundary conditions as a result of changing traffic regulations, it is possible to switch between significantly different data records without this indicating a problem situation that cannot be resolved. It can also be taken into account that a ground vehicle can pass traffic lights that either allow it to pass or force it to stop. Such a traffic signal can be detected comparatively easily by the measuring system so that the selection unit can select the most suitable data record depending on whether the vehicle must stop at the traffic lights or can pass through them.

The selection unit of some embodiments is designed to select one of several stored records depending on the vital data measured by the measurement system to estimate the physical strain on a rider. If the means of transport is muscle-powered, the measured vital data can indicate that the rider is overloaded and trigger a change to a less strenuous data record. In addition, in the case of a means of transport powered by a drive unit, for example, a high heart rate can also indicate a high level of excitement on the part of the rider, which can trigger a change to a more defensive and/or less exciting riding style by selecting a correspondingly more defensive data record from the selection unit.

The selection unit of some embodiments is designed to select one of several stored records depending on an individually selected driving program, in particular a first driving program for a consumption-optimized journey and a second driving program for a maximum performance-optimized second driving program. The driver can select whether a sportier or consumption-optimized driving mode should take place. The selection unit then can select the most suitable data record for the selected driving program. This makes it possible to take into account that an optimization target for the shift state of the variator can also be variable.

The selection unit may be designed to select one of several stored records depending on the load of the means of transport measured with the aid of the measuring system. Here it can be taken into account that the inert mass to be accelerated and centrifugal forces during cornering can change with a low and a high load on the means of transport and, not least for safety reasons, other settings on the variator are more suitable in each case. In addition, the consumption behavior of the means of transport can change depending on the load, so that achieving a certain specified range with a limited energy supply makes different settings on the variator appear sensible.

The comparative data stored in the database is based on measured values of the same driver and/or different drivers from the current driver measured by the measuring system. It is possible to provide a data record personalized for a specific driver and that comparative data can be adapted in a special way to the driving style of the driver in question. The driving experience can thus be adapted easily to individual preferences. In particular, if no individualized data record is available for a specific route that corresponds to a specific position profile, a data record stored for another person or an average of different data records or a default data record can be used. Thus, a data record can be selected of the person that is as similar as possible for another position profile for which an individualized data record of the current driver is available. This makes it possible to select a data record for a route that the current driver has not yet driven but that most closely corresponds to the driving style of the current driver.

A further aspect relates to a method for operating a means of transport that can be designed and further developed as described above. The method of some embodiments includes a step of providing a database that has comparative data for at least one specific position profile of the means of transport and more than one record of stored switching states of a variator of the means of transport for the respective position of the position profile. The method may proceed by selecting one of a plurality of records of switching states stored in the database for the current position as a function of a predefined selection criterion, and using the selected record for display to a driver and/or for automatic adjustment of the variator. In particular, the method can be designed and further developed as explained above with reference to the means of transport. Due to the several records of switching states that can be selected by the selection unit, a record that is better optimized for changing boundary conditions can be used for a current position profile of the means of transport. Thus, the variator enables a means of transport that is efficiently adapted to the current situation even under different boundary conditions.

The selection criterion used in the method may comprise one or more measurement data selected from the group comprising, in particular consisting of, travel speed, weather conditions, currently applicable traffic regulations, vital data of a driver, an individually selected driving program and/or loading of the means of transport. As explained above with reference to the means of transport, a single one of these selection criteria and a combination of two or more of these selection criteria can identify several data records of switching states for the variator assigned to a position profile in order to be able to select a suitable operation of the means of transport for the driving situation identified in each case.

The invention is explained below by way of an example with reference to the appended drawing using an exemplary embodiment. The features shown below can represent an aspect of the invention both individually and in combination.

### BRIEF DESCRIPTION OF THE DRAWINGS

FIG. 1 is a schematic diagram of a means of transport.

### DETAILED DESCRIPTION

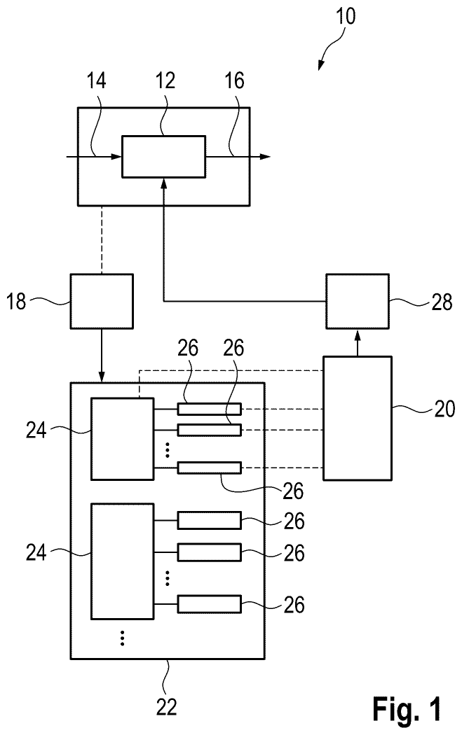

A means of transport 10 is illustrated schematically in FIG. 1 and has a variator 12, for example a gear shift or a transmission, that can convert a drive torque 14 into an output torque 16 for movement of the means of transport 10. A measuring system 18 can measure various parameters. With the aid of a position profile measured by the measuring system 18, a selection unit 20 can select comparison data 24 stored in a database 22 for this position profile. The comparison data 24 can have different (data) records 26 indexed for different selection criteria. Depending on this selection criterion, which was preferably measured by the measuring system 18, the selection unit 20 can, if necessary, select the most suitable record 26 for the current driving situation on the basis of a suitable selection algorithm and send it to an output unit 28. The output unit 28 can display a switching state stored for the current position from the selected data record 26 to the driver so that the driver can adjust the variator accordingly, or the variator can adjust itself accordingly.

The records 26 stored for the respective position profile can be learned from a previous behavior of the driver along this position profile, possibly with the help of an AI, for example by storing the switching states of the variator 12 along this position profile and, if necessary, forming a corresponding data record 26 from several comparable stored data after averaging them. If the stored data differ too greatly from one another, this is more likely to indicate different boundary conditions, for each of which a separate data record 26 is learned.

1. A means of transport (10) for transporting a person on ground, on water and/or in air, comprising:
a variator (12), for changing a transmission ratio between a drive torque (14) and an output torque (16) and/or output thrust;
a measuring system (18) for measuring a position of the means of transport (10), a position course of the means of transport (10), a transport speed of the means of transport (10) and a switching state of the variator (12);
a database (22) containing comparison data (24), for various position profiles, the comparison data (24) having stored switching states (26) for respective positions of the position profile; and
an output unit (28) for proposing a switching state stored in the database (22) for a current position and/or for automatically setting the switching state stored for the current position in the variator (12), wherein:
the comparison data for at least one specific position profile has more than one record (26) of stored switching states for the respective position of the position profile, and
a selection unit (20) is provided for selecting one of the records for the output unit (28).

2. The means of transport (10) of claim 1, wherein the selection unit (20) is configured to select one of a plurality of stored switching states (26) as a function of a current transport speed.

3. The means of transport (10) of claim 1, wherein the selection unit (20) is configured to select one of a plurality of stored switching states (26) depending on current weather conditions.

4. The means of transport (10) of claim 1, wherein the selection unit (20) is configured to select one of a plurality of stored switching states (26) depending on currently applicable traffic regulations.

5. The means of transport (10) of claim 1, wherein the selection unit (20) is configured to select one of a plurality of stored switching states (26) as a function of vital data measured with the aid of the measuring system (18) for estimating a physical strain on a rider.

6. The means of transport (10) of claim 1, wherein the selection unit (20) is configured to select one of a plurality of stored switching states (26) as a function of an individually selected a first driving program for a consumption-optimized journey and a second driving program for a maximum performance-optimized second driving program.

7. The means of transport (10) of claim 1, wherein the selection unit (20) is configured to select one of a plurality of stored switching states (26) depending on a load of the means of transport (10) measured with the aid of the measuring system (18).

8. The means of transport (10) of claim 1, wherein the comparison data (24) stored in the database (22) is based on measured values of the same driver and/or different drivers from the current driver measured by the measuring system (18).

9. A method for operating a means of transport (10), comprising:
providing a database (22) that comprises comparison data (24) for at least one specific position profile of the means of transport (10) and more than one record (26) of stored switching states of a variator (12) of the means of transport (10) for the respective position of the position profile;
selecting one of a plurality of records (26) of switching states stored in the database (22) for the current position as a function of a predefined selection criterion; and
using the selected record (26) for display to a driver and/or for automatic adjustment of the variator (12).

10. The method of claim 9, wherein the selection criterion comprises one or more measurement data selected from the group consisting of transport speed, weather conditions, currently applicable traffic regulations, vital data of a driver, individually selected driving program and/or loading of the means of transport
